(19) United States
(12) Patent Application Publication
(10) Pub. No.: US 2015/0356307 A1
(43) Pub. Date: Dec. 10, 2015

(54) SAFE INPUT METHOD AND SYSTEM

(71) Applicant: Tencent Technology (Shenzhen) Company Limited, Shenzhen (CN)

(72) Inventors: Rui MAO, Shenzhen (CN); Zan ZOU, Shenzhen (CN)

(73) Assignee: Tencent Technology (Shenzhen) Company Limited

(21) Appl. No.: 14/830,288

(22) Filed: Aug. 19, 2015

Related U.S. Application Data
(63) Continuation of application No. PCT/CN2013/088148, filed on Nov. 29, 2013.

(30) Foreign Application Priority Data
Feb. 26, 2013 (CN) 201310060190.1

(51) Int. Cl. G06F 21/60; G06F 9/455

(52) U.S. Cl. CPC G06F 21/602; G06F 9/45558; G06F 2009/45587; G06F 2009/45591

(57) ABSTRACT

A safe input method and system are provided. The method includes: starting a virtual machine mode of a central processing unit when safe input is to be performed; in the virtual machine mode, switching a guest operating system into a non-root mode, and switching a virtual machine monitor allocated for a safe input protection program into a root mode; receiving, by the guest operating system, input data of a user, and transmitting the input data of the user to the virtual machine monitor; encrypting and saving, by the virtual machine monitor, the input data to be retrieved by an authorized program; generating, by the virtual machine monitor, false input data, and returning the false input data to the guest operating system; and shutting down the virtual machine mode of the central processing unit when it is confirmed that the safe input is completed.

### RELATED APPLICATION

This application is a continuation of International Application No. PCT/CN2013/088148, filed on Nov. 29, 2013, which claims priority to Chinese Patent Application No. 201310060190.1, entitled “SAFE INPUT METHOD AND SYSTEM” filed on Feb. 26, 2013, both of which are hereby incorporated by reference in their entireties.

### FIELD OF THE TECHNOLOGY

The present disclosure relates to the field of communications technologies, and in particular, to a safe input method and system.

### BACKGROUND OF THE DISCLOSURE

The rapid development of the network technology makes people's life more convenient, but at the same time, it also brings about serious challenge to personal information security. In the existing technology, hackers or unauthorized users often use Trojan horses to steal personal information of users. In order to prevent such harms through the network, various security solutions have been proposed, and how to ensure safe input is one of the solutions.

### SUMMARY

Embodiments of the present disclosure provide a safe input method and system. The method and system allow a user not to change use habits or configure additional hardware, and can prevent the Trojan horses from intercepting or tampering with input content of the user effectively, and thus the accuracy and the security of information are improved.

A safe input method includes:

starting a virtual machine mode of a central processing unit (CPU) when safe input is to be performed;

in the virtual machine mode, switching a guest operating system (Guest OS) into a non-root mode, and switching a virtual machine monitor (VMM) allocated for a safe input protection program into a root mode;

receiving, by the guest operating system, input data of a user, and transmitting the input data to the virtual machine monitor;

encrypting and saving, by the virtual machine monitor, the input data to be retrieved by an authorized program; generating, by the virtual machine monitor, false input data; and returning the false input data to the guest operating system; and

shutting down the virtual machine mode of the CPU when it is confirmed that the safe input is completed.

A safe input system includes:

a starting unit, configured to start a virtual machine mode of a CPU when safe input is to be performed;

a switching unit, configured to in the virtual machine mode, switch a guest operating system into a non-root mode, and to switch a virtual machine monitor of safe input protection program into a root mode;

a processing unit, configured to make the guest operating system receive input data of a user, and transmit the input data of the user to the virtual machine monitor of the safe input protection program; make the virtual machine monitor encrypt and save the input data to be retrieved by an authorized program; and make the virtual machine monitor generate false input data and return the false input data to the guest operating system; and

a shutdown unit, configured to shut down the virtual machine mode of the CPU when it is confirmed that the safe input of the user is completed.

In the embodiments of the present disclosure, the virtual machine mode of the CPU is started when it is confirmed that the user is to perform safe input, and the guest operating system is switched into the non-root mode, and the virtual machine monitor allocated for the safe input protection program is switched into the root mode. In this case, the guest operating system does not process the input data immediately when receiving the input data of the user. Instead, the input data is transmitted to the virtual machine monitor, and the virtual machine monitor encrypts and saves the input data to be retrieved by the authorized program. After that, the virtual machine monitor generates the false input data and returns the false input data to the guest operating system. In this way, either a keyboard hook of a kernel layer or a message hook of an application layer has no chance to process the input data. Therefore, the accuracy and the authenticity of the information are ensured. In addition, the false input data is returned to the Guest OS, so even if the false input data is stolen by a Trojan horses, it is useless to the hackers or unauthorized users, while the authorized program can obtain the correct input data of the user by directly retrieving the correct input data from the virtual machine monitor. Therefore, the information security is improved while ensuring the normal use of the input data by the system. In addition, this function is triggered and started only when the user needs to perform safe input, and thus the function of the system and the normal use by the user are not affected. In this way, this solution allows the user not to change use habits or configure additional hardware, and can effectively prevent the Trojan horses from intercepting or tampering with the input content of the user, thereby improving accuracy and security of information.

### BRIEF DESCRIPTION OF THE DRAWINGS

In order to illustrate the technical solutions of the embodiments of the present disclosure more clearly, accompanying drawings that need to be used in the embodiments will be described below. Apparently, the accompanying drawings described below are only some embodiments of the present disclosure. Persons skilled in the art may obtain other drawings according to these accompanying drawings without creative efforts.

FIG. 1a is a schematic diagram of an operation of a virtual machine monitor;

FIG. 1b is a flowchart of a safe input method according to an embodiment of the present disclosure;

FIG. 2 is a flowchart of another safe input method according to an embodiment of the present disclosure; and

FIG. 3 is a schematic structural diagram of a safe input system according to an embodiment of the present disclosure.

### DESCRIPTION OF EMBODIMENTS

Technical solutions of embodiments of the present disclosure will be described clearly and completely in the following with reference to the accompanying drawings of the embodiments of the present disclosure. Apparently, the described embodiments are only a part of embodiments of the present disclosure instead of all embodiments of the present disclosure. Based on the embodiments in the specification, all other embodiments obtained by persons skilled in the art without creative efforts shall fall within the protection scope of the present disclosure.

To describe the embodiments of the present disclosure better, the virtualization technology is described briefly below.

Virtualization refers to an abstraction of computer resources. It hides a physical aspect of the computer resources on which the system, applications and end users rely to interact. The most common method is to convert a single physical resource into multiple logical resources. Certainly, multiple physical resources may also be converted into a single logical resource.

Hardware enabled virtualization (HEV) provides direct support to the virtualization technology on the hardware level, to be more specific, in the CPU, thereby improving virtualization efficiency and reducing development difficulty. Before the hardware virtualization technology was developed, in a process of programming a virtual machine, in order to achieve real physical address isolation of multiple virtual machines, a physical address of a guest machine needs to be translated into a physical address of a real machine by programming. At the same time, different virtual device drivers must be programmed for different operating systems of guest machines to enable them to share the same real hardware resource. The hardware virtualization technology achieves mapping between a memory address and an input/output (I/O) device on the hardware level, and thus the process of programming the virtual machine is greatly simplified. The features of directly supporting secondary addressing and I/O mapping by the hardware also improve the performance of the virtual machine during running.

In the hardware virtualization technology, an important concept is virtual machine monitor (VMM), which specifically refers to a privileged layer created when the hardware virtualization technology is used. This layer is provided for virtual machine developers, to implement communication between virtual hardware and real hardware and to process other events. A permission level of the virtual machine monitor is higher than or equal to a permission level of the Guest OS.

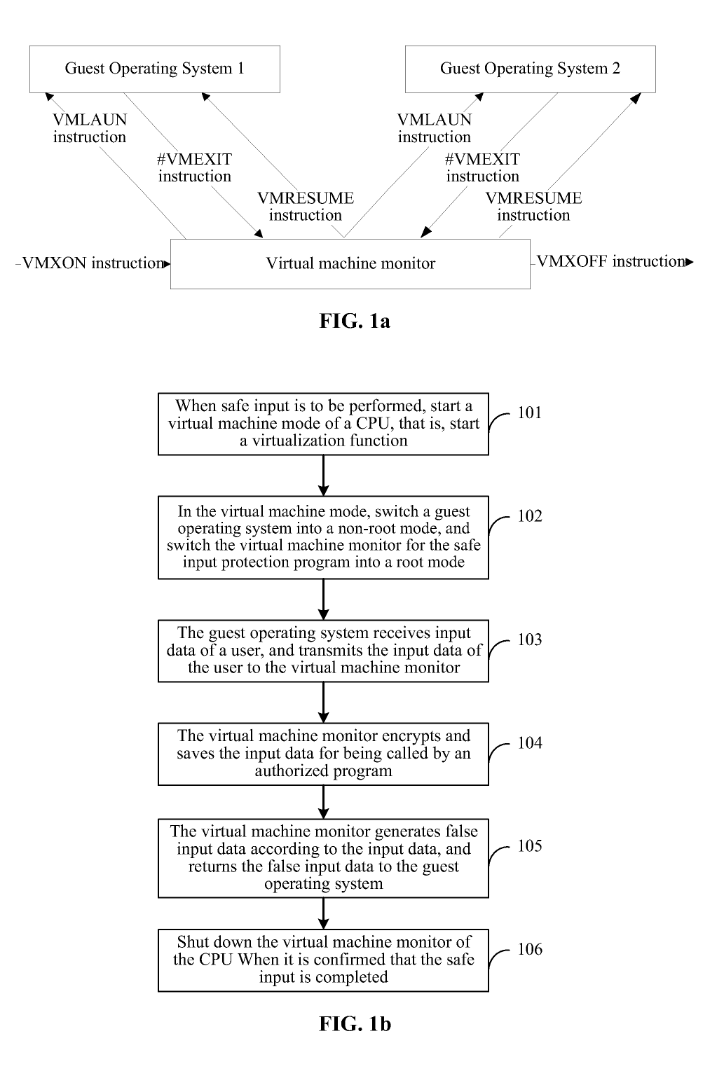

In the virtualization technology, the design architecture may mainly include the virtual machine monitor and the guest machine, which are in a root mode and a non-root mode respectively. An operation of the virtual machine monitor in the VT technology is shown in FIG. 1a. It can be known from FIG. 1a that by executing a VMXON instruction in an extension instruction set of the virtual machine, the software enters the root mode, establishing an operating environment for the virtual machine monitor. Then, by using a VMLAUNCH instruction, a target system can run in the virtual machine normally. When a certain instruction generates a “#VMEXIT” event, the virtual machine monitor performs the “#VMEXIT” event. After the processing on the event is completed, the right of control is handed to the virtual machine that generates the “#VMEXIT” event by using a VMRESUME event. The VMM is not shut down until a certain moment when a VMXOFF instruction in the extension instruction set of the virtual machine is called explicitly in the VMM.

In addition, the VT technology supports an interception operation on various events, such as the execution of a sensitive instruction and an I/O operation.

The embodiments of the present disclosure provide a safe input method and system. Detailed descriptions will be made in the following.

### Embodiment 1

This embodiment is described from the perspective of a safe input system.

A safe input method includes: starting a virtual machine mode of a CPU when safe input is to be performed; switching a guest operating system (Guest OS) into a non-root mode and switching the virtual machine monitor allocated for a safe input protection program into a root mode according to the virtual machine mode; receiving, by the guest operating system, input data of a user, and transmitting the input data of the user to the virtual machine monitor; encrypting and saving, by the virtual machine monitor, the input data to be retrieved by an authorized program; generating, by the virtual machine monitor, false input data according to the input data, and returning the false input data to the guest operating system; shutting down the virtual machine mode of the CPU when it is confirmed that the safe input is completed.

As shown in FIG. 1b, a specific process of the method is as follows.

101. When safe input is to be performed, start a virtual machine mode of a CPU, that is, start a virtualization function.

After starting the virtual machine mode, the system allocates the virtual machine monitor for each program. That is, at this time, the system allocates a virtual machine monitor for a safe input protection program.

102. In the virtual machine mode, switch a guest operating system into a non-root mode, and switch the virtual machine monitor for the safe input protection program into a root mode.

For example, specifically, in the virtual machine mode, the guest operating system is switched into the non-root mode and the virtual machine monitor is switched into the root mode, by using a VMXON instruction in the extension instruction set of the virtual machine.

103. The guest operating system receives input data of a user, and transmits the input data of the user to the virtual machine monitor.

For example, specifically, the guest operating system receives the input data of the user, and executes a VMEXIT instruction, and then the input data is transmitted to the VMM, which is as follows:

When the virtual machine mode is not started, if a hardware driver layer of the guest operating system intercepts the input data that the user inputs through a keyboard (that is, intercepts an I/O operation), the guest operating system transfers the input data to the keyboard driver for processing. However, if the virtual machine mode is started (that is, step 101 is performed), before processing the input data (that is, the I/O operation), the guest operating system first performs a “#VMEXIT” operation so that the I/O operation enters the virtual machine monitor from the guest operating system, that is, the input data is sent to the virtual machine monitor.

In addition, after the virtual machine mode is started, only one instance can run in the virtual machine monitor, so as to ensure the exclusivity of information processing. Further, the “#VMEXIT” operation is earlier than any other processing operation of the guest operating system, and thus a keyboard hook of a kernel layer or a message hook of an application layer has no chance to process the input data. Therefore, the accuracy and the authenticity of the information are ensured, that is, the input data is not tampered with or intercepted before the “#VMEXIT” operation.

104. The virtual machine monitor encrypts and saves the input data to be retrieved by an authorized program, that is, the authorized program can obtain the authentic input data of the user by directly retrieving the correct input data from the virtual machine monitor.

105. The virtual machine monitor generates false input data according to the input data, and returns the false input data to the guest operating system.

Because the input data returned to the guest operating system is false, even if the false input data is stolen by a Trojan horse, it will not cause harm to the information security.

106. Shut down the virtual machine monitor of the CPU when it is confirmed that the safe input is completed.

For example, specifically, when it is confirmed that the safe input is completed, the virtual machine mode of the CPU is shut down by using a VMXOFF in the extension instruction set of the virtual machine, so that the guest operating system exits the virtual machine mode seamlessly.

After the virtual machine mode is shut down, non-root mode or root mode do not exist, and the guest operating system returns to the original Ring0 layer. Thus, the whole procedure of this solution is transparent to the user, and the input of the user is not affected during this process.

From the foregoing, in this embodiment, when it is confirmed that the safe input is to be performed, the virtual machine mode of the CPU is started, and the guest operating system is switched into the non-root mode and the virtual machine monitor allocated for the safe input protection program is switched into the root mode, according to the virtual machine mode. In this case, the guest operating system does not process the input data immediately after receiving the input data of the user. Instead, the input data is transmitted to the virtual machine monitor, and the virtual machine monitor encrypts and saves the input data to be retrieved by the authorized program. The virtual machine monitor then generates the false input data and returns the false input data to the guest operating system. In this way, a keyboard hook of a kernel layer or a message hook of an application layer has no chance to process the input data. Therefore, the accuracy and the authenticity of the information are ensured. In addition, the input data returned to the guest operating system is false, so even if the false input data is stolen by the Trojan horses, it is useless. The authorized program can obtain the correct input data of the user by directly calling the virtual machine monitor. Therefore, the information security is improved while ensuring the normal use of the input data by the system. In addition, this function is started only when the user needs to perform the safe input, and thus the system and the normal use of the user are not affected. In this way, this solution allows the user not to change use habits or configure additional hardware, and can effectively prevent the Trojan horses from intercepting or tampering with the input content of the user, so that the accuracy and the security of the information are improved.

### Embodiment 2

According to the method described in Embodiment 1, another embodiment is given in the following for further detailed description.

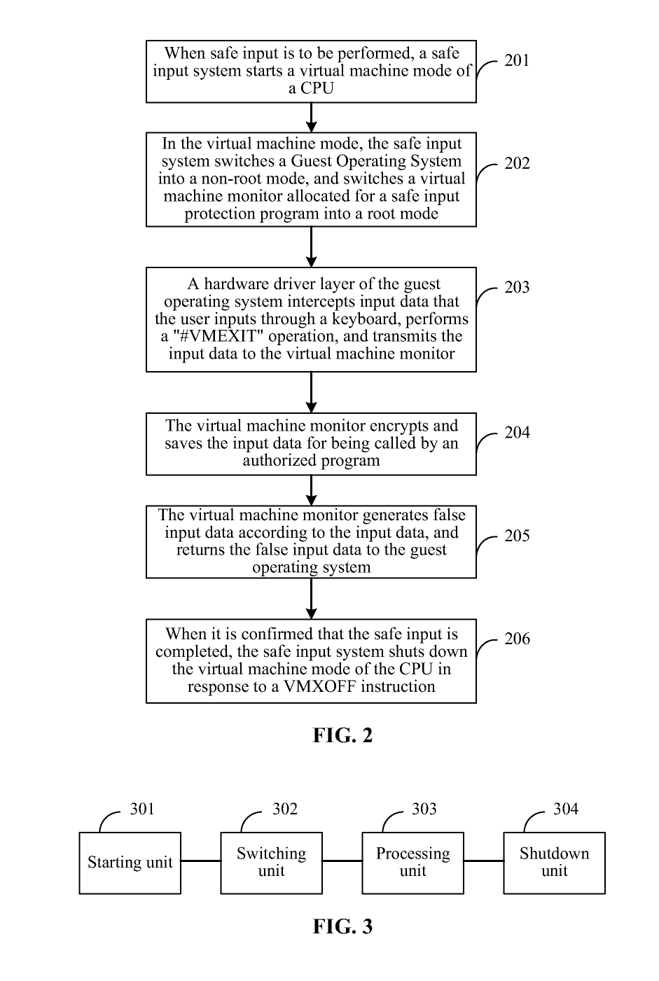

As shown in FIG. 2, a safe input method is provided, and the specific procedures are as follows.

201. When safe input is to be performed, a safe input system starts a virtual machine mode of a CPU, that is, starts a virtualization function.

After starting the virtual machine mode, the system allocates a virtual machine monitor for each program. That is, at this time, the system allocates a virtual machine monitor for a safe input protection program.

202. In the virtual machine mode, the safe input system switches a guest operating system into a non-root mode in response to a VMXON instruction, and switches the virtual machine monitor of the safe input protection program into a root mode in response to the VMXON instruction.

203. A hardware driver layer of the guest operating system intercepts input data that a user inputs through a keyboard, that is, intercepts an I/O operation. Because the virtual machine mode is started at this time, the hardware driver layer of the guest operating system will first perform a “#VMEXIT” operation, to make the I/O operation enter the virtual machine monitor from the guest operating system, that is, transmit the input data to the virtual machine monitor.

204. The virtual machine monitor encrypts and saves the input data for being called by an authorized program. That is, the authorized program can obtain the correct input data of the user by directly retrieving from the virtual machine monitor.

205. The virtual machine monitor generates false input data according to the input data, and returns the false input data to the guest operating system.

Because the false input data is returned to the guest operating system at this time, even if the false input data is stolen by a Trojan horse, it will not cause harm to the information security.

206. When it is confirmed that the safe input of the user is completed, the safe input system shuts down the virtual machine mode of the CPU in response to a VMXOFF instruction. In this way, the guest operating system exits seamlessly from the virtual machine mode, and the guest operating system returns to the original Ring0 layer.

From the foregoing, in this embodiment, when the safe input is to be performed, the safe input system starts the virtual machine mode of the CPU, and the guest operating system is switched into the non-root mode and the virtual machine monitor allocated for the safe input protection program is switched into the root mode according to the virtual machine mode. In this case, the guest operating system does not process the input data immediately when receiving the input data of the user, that is, when intercepting an I/O operation. Instead, the Guest OS performs a “#VMEXIT” operation, to enable the I/O operation to enter the virtual machine monitor from the guest operating system, and the virtual machine monitor encrypts and saves the input data to be retrieved by the authorized program. The virtual machine monitor generates the false input data and returns the false input data to the guest operating system. In this way, a keyboard hook of a kernel layer or a message hook of an application layer has no chance to process the input data. Therefore, the accuracy and the authenticity of the information are ensured. In addition, the false input data is returned to the guest operating system, so even if the false input data is stolen by the Trojan horses, it is useless to the hackers or unauthorized users, while the authorized program can obtain the correct input data of the user by directly retrieving the correct input data from the virtual machine monitor. Therefore, the information security is improved while ensuring the normal use of the input data by the system. In addition, this function is started only when the user needs to perform the safe input, and thus the function of the system and the normal use of the user are not affected. In this way, this solution allows a user not to change use habits or configure additional hardware, and can prevent the Trojan horses from intercepting or tampering with the input content of the user effectively, so that the accuracy and the security of the information are improved.

### Embodiment 3

In order to implement the above method better, this embodiment of the present disclosure also provides a safe input system. As shown in FIG. 3, the safe input system includes a starting unit 301, a switching unit 302, a processing unit 303, and a shutdown unit 304.

The starting unit 301 is configured to start a virtual machine mode of a CPU when safe input is to be performed.

After starting the virtual machine mode, the system allocates a virtual machine monitor for each program. That is, at this time, the system allocates a virtual machine monitor for a safe input protection program.

The switching unit 302 is configured to switch a guest operating system into a non-root mode and switch the virtual machine monitor allocated for the safe input protection program into a root mode, in the virtual machine mode.

The processing unit 303 is configured to make the guest operating system receive input data of a user, and transmit the input data of the user to the virtual machine monitor; make the virtual machine monitor encrypt and save the input data for being called by an authorized program; and make the virtual machine monitor generate false input data according to the input data, and return the false input data to the guest operating system.

The shutdown unit 304 is configured to shut down the virtual machine mode of the CPU when the safe input is completed.

For example, the switching unit 302 is specifically configured to in the virtual machine mode, switch the guest operating system into the non-root mode and switch the virtual machine monitor into the root mode in response to a VMXON instruction.

The processing unit 303 is specifically configured to make the guest operating system receive the input data of the user, execute a VMEXIT instruction to transmit the input data to the virtual machine monitor, which is described as follows.

When the virtual machine mode is not started, if a hardware driver layer of the guest operating system intercepts the input data which is input by the user through a keyboard (that is, intercepts an I/O operation), the guest operating system hands the input data to the keyboard driver for processing. However, if the virtual machine mode is started (that is, step 101 is performed), before the guest operating system processes the input data (that is, the I/O operation), the processing unit 303 first performs a “#VMEXIT” operation, to make the I/O operation enter the virtual machine monitor from the guest operating system, that is, transmit the input data to the virtual machine monitor.

In addition, after the virtual machine mode is started, only one instance can run in the virtual machine monitor, and thus the exclusivity of information processing can be ensured. Further, the “#VMEXIT” operation is earlier than any other processing operation of the guest operating system, so a keyboard hook of a kernel layer or a message hook of an application layer has no chance to process the input data. Therefore, the accuracy and the authenticity of the information are ensured, that is, the input data is not tampered with or intercepted before the “#VMEXIT” operation.

The shutdown unit 304 is specifically configured to shut down the virtual machine mode of the CPU in response to a VMXOFF instruction when the safe input of is completed.

After the shutdown unit 304 shuts down the virtual machine mode, the non-root mode or the root mode do not exist, and the guest operating system returns to the original Ring0 layer. Therefore, the whole procedure of this solution is transparent to the user, and the input of the user is not affected during this process.

During specific implementation, each unit above may be implemented as an independent entity, or as the same or several entities through any combination. Reference may be made to the method embodiment described above for specific embodiments of the units, which are not described herein.

From the foregoing, in the safe input system according to this embodiment, when the safe input is to be performed, the starting unit 301 can start the virtual machine mode of the CPU, and the switching unit 302 switches the guest operating system into the non-root mode and switches the virtual machine monitor allocated for the safe input protection program into the root mode. In this case, the guest operating system does not process the input data immediately when receiving the input data of the user, that is, when intercepting an I/O operation. Instead, the safe input system enables the processing unit 303 to perform a “#VMEXIT” operation, to make the I/O operation enter the virtual machine monitor from the guest operating system, and the virtual machine monitor encrypts and saves the input data for being called by the authorized program. Then, the virtual machine monitor generates the false input data and returns the false input data to the guest operating system. In this way, a keyboard hook of a kernel layer or a message hook of an application layer has no chance to process the input data. Therefore the accuracy and the authenticity of the information are ensured. In addition, the false input data is returned to the Guest OS, so even if the false input data is stolen by a Trojan horse, it is useless, while the authorized program can obtain the correct input data of the user by directly calling the VMM. Therefore, under the premise of ensuring the normal use of the input data by the system, the information security is improved. In addition, this function is started only when the user needs to perform the safe input, and thus the system and the normal use of the user are not affected. In this way, this solution allows the user not to change use habits or configure additional hardware, and can prevent the Trojan horses from intercepting or tampering with the input content of the user effectively, so that the accuracy and the security of the information are improved.

Persons of ordinary skill in the art may understand that all or part of the steps of various methods in the embodiments above may be completed by a program that instructs relevant hardware. The program may be stored in a computer readable storage medium. The storage medium may include: a read only memory (ROM), a random access memory (RAM), a magnetic disk, or an optical disk.

The above describes a safe input method and system provided by the embodiments of the present disclosure in detail. Specific examples are used to illustrate the principle and the implementation manners of the present disclosure. The above embodiments are only used to help understand the methodology and concept of the present disclosure. Persons skilled in the art can make variations to the specific implementation manners and application scope according to the idea of the present disclosure. In conclusion, the content of the specification should not be understood as a limitation to the present disclosure.

What is claimed is:

1. A safe input method, comprising:
starting, by a computer, a virtual machine mode of a central processing unit when safe input is to be performed;
in the virtual machine mode, switching, by the computer, a guest operating system into a non-root mode, and switching, by the computer, a virtual machine monitor allocated for a safe input protection program into a root mode;
receiving, by the guest operating system, input data of a user, and transmitting the input data of the user to the virtual machine monitor;
encrypting and saving, by the virtual machine monitor, the input data to be retrieved by an authorized program;
generating, by the virtual machine monitor, false input data, and returning the false input data to the guest operating system; and
shutting down, by the computer, the virtual machine mode of the central processing unit when it is confirmed that the safe input is completed.

2. The method according to claim 1, further comprising:
in the virtual machine mode, switching the guest operating system into the non-root mode and switching the virtual machine monitor allocated for the safe input protection program into the root mode, in response to a starting instruction.

3. The method according to claim 1, further comprising:
receiving, by the guest operating system, the input data of the user, and executing an instruction for exiting a virtual machine, to transmit the input data to the virtual machine monitor.

4. The method according to claim 1, further comprising:
shutting down the virtual machine mode of the central processing unit in response to a shutdown instruction when it is confirmed that the safe input is completed.

5. A safe input system, comprising:
a starting unit that starts a virtual machine mode of a central processing unit when safe input is to be performed;
a switching unit that, in the virtual machines mode, switches a guest operating system into a non-root mode, and switches a virtual machine monitor allocated for a safe input protection program into a root mode;
a processing unit that makes the guest operating system receive input data of a user, and transmit the input data of the user to the virtual machine monitor of the safe input protection program; that makes the virtual machine monitor encrypt and save the input data to be retrieved by an authorized program; and that makes the virtual machine monitor generate false input data according to the input data and return the false input data to the guest operating system; and
a shutdown unit that shuts down the virtual machine mode of the central processing unit when it is confirmed that the safe input is completed.

6. The safe input system according to claim 5, wherein
the switching unit, in the virtual machines mode, switches the guest operating system into the non-root mode and switches the virtual machine monitor for the safe input protection program into the root mode, in response to a starting instruction.

7. The safe input system according to claim 5, wherein
the processing unit makes the guest operating system receive the input data of the user, and executes an instruction for exiting a virtual machine, to transmit the input data to the virtual machine monitor.

8. The safe input system according to claim 5, wherein
the shutdown unit shuts down the virtual machine mode of the central processing unit in response to a shutdown instruction when it is confirmed that the safe input is completed.

9. A non-transitory computer storage medium comprising a computer executable instruction, wherein the computer executable instruction is adapted to perform a safe input method, comprising:
starting a virtual machine mode of a central processing unit when safe input is to be performed;
in the virtual machine mode, switching a guest operating system into a non-root mode, and switching a virtual machine monitor allocated for a safe input protection program into a root mode;
receiving, by the guest operating system, input data of a user, and transmitting the input data of the user to the virtual machine monitor;
encrypting and saving, by the virtual machine monitor, the input data to be retrieved by an authorized program;
generating, by the virtual machine monitor, false input data, and returning the false input data to the guest operating system; and
shutting down the virtual machine mode of the central processing unit when it is confirmed that the safe input is completed.

10. The non-transitory computer storage medium according to claim 9, wherein in the virtual machine mode, the switching a guest operating system into a non-root mode and switching a virtual machine monitor allocated for a safe input protection program into a root mode comprises:
in the virtual machine mode, switching the guest operating system into the non-root mode and switching the virtual machine monitor allocated for the safe input protection program into the root mode, in response to a starting instruction.

11. The non-transitory computer storage medium according to claim 9, wherein the receiving, by the guest operating system, input data of a user, and transmitting the input data of the user to the virtual machine monitor comprises:
receiving, by the guest operating system, the input data of the user, and executing an instruction for exiting a virtual machine, to transmit the input data to the virtual machine monitor.

12. The non-transitory computer storage medium according to claim 9, wherein the shutting down the virtual machine mode of the central processing unit when it is confirmed that the safe input is completed comprises:
shutting down the virtual machine mode of the central processing unit in response to a shutdown instruction when it is confirmed that the safe input is completed.
